(19) United States
(12) Patent Application Publication
(10) Pub. No.: US 2019/0157671 A1
(43) Pub. Date: May 23, 2019

(54) POSITIVE ACTIVE MATERIAL FOR RECHARGEABLE LITHIUM BATTERY AND RECHARGEABLE LITHIUM BATTERY INCLUDING SAME

(71) Applicant: Samsung SDI Co., Ltd., Yongin-si (KR)

(72) Inventors: Young-Hun LEE, Yongin-si (KR); Hyunjei CHUNG, Yongin-si (KR); Yongmok CHO, Yongin-si (KR); Yoonyoung CHOI, Yongin-si (KR); Ickkyu CHOI, Yongin-si (KR)

(21) Appl. No.: 16/194,006

(22) Filed: Nov. 16, 2018

(30) Foreign Application Priority Data
Nov. 17, 2017 (KR) 10-2017-0153880

(51) Int. Cl. H01M 4/525; H01M 10/0525

(52) U.S. Cl. CPC H01M 4/525; H01M 2004/028; H01M 10/0525

(57) ABSTRACT

A positive active material for a rechargeable lithium battery and a rechargeable lithium battery including the same are provided. The positive active material for a rechargeable lithium battery may include a compound represented by Chemical Formula 1:

Li₁₊ₓ₁Co₁₋ₓ₂₋ₓ₃₋ₓ₄M1ₓ₂M2ₓ₃M3ₓ₄O₂. Chemical Formula 1

In Chemical Formula 1, 0<x1≤0.03, 0.005≤x2≤0.02, 0.01≤x3≤0.025, 0≤x4≤0.005, and x2+x3>0.01; M1 may be selected from Mg, Na, Ca, and a combination thereof; M2 may be selected from Al, B, Fe, and a combination thereof; and M3 may be selected from Ti, Zr, V, Cr, Mo, W, Mn, Ni, Cu, Ag, Zn, Si, Sn, N, P, S, F, Cl, and a combination thereof.

### CROSS-REFERENCE TO RELATED APPLICATION

This application claims priority to and the benefit of Korean Patent Application No. 10-2017-0153880 filed in the Korean Intellectual Property Office on Nov. 17, 2017, the entire content of which is incorporated herein by reference.

### BACKGROUND

### 1. Field

Aspects of embodiments of the present disclosure are related to a positive active material for a rechargeable lithium battery and a rechargeable lithium battery including the same.

### 2. Description of the Related Art

Recently, the high-tech electronic industry has focused on developing portable electronic devices with a smaller size and a lighter weight. Rechargeable lithium batteries having a long life-span and a high energy density are widely used as power sources for portable electronic devices.

A rechargeable lithium battery includes a positive electrode including a positive active material, a negative electrode including a negative active material, an electrolyte, a separator, and the like.

Rechargeable lithium batteries used in portable electronic devices are becoming widely used in other industry fields such as power tools and vehicles, so rechargeable lithium batteries with a high capacity are a topic of active research and development. For example, research on improving the performance of the positive active material (one of the essential elements of the rechargeable lithium battery), is being performed to ensure that rechargeable lithium batteries can have excellent cycle-life and storage characteristics even under high temperature and high voltage conditions.

### SUMMARY

One or more aspects of example embodiments of the present disclosure are directed toward a positive active material for a rechargeable lithium battery that is capable of improving the stability, storage characteristics, and cycle-life characteristics of the battery under high voltage conditions, and a rechargeable lithium battery including the same.

One or more example embodiments of the present disclosure provide a positive active material for a rechargeable lithium battery including a compound represented by Chemical Formula 1:

Li₁₊ₓ₁Co₁₋ₓ₂₋ₓ₃₋ₓ₄M1ₓ₂M2ₓ₃M3ₓ₄O₂. Chemical Formula 1

In Chemical Formula 1,

0<x1≤0.03, 0.005≤x2≤0.02, 0.01≤x3≤0.025, 0≤x4≤0.005, and x2+x3>0.01,

M1 may be selected from magnesium (Mg), sodium (Na), calcium (Ca), and a combination thereof,

M2 may be selected from aluminum (Al), boron (B), iron (Fe), and a combination thereof, and

M3 may be selected from titanium (Ti), zirconium (Zr), vanadium (V), chromium (Cr), molybdenum (Mo), tungsten (W), manganese (Mn), nickel (Ni), copper (Cu), silver (Ag), zinc (Zn), silicon (Si), tin (Sn), nitrogen (N), phosphorus (P), sulfur (S), fluorine (F), chlorine (CI), and a combination thereof.

One or more example embodiments of the present disclosure provide a rechargeable lithium battery including a positive electrode, a negative electrode, and an electrolyte solution, wherein the positive electrode includes the positive active material for a rechargeable lithium battery according to one or more embodiments of the present disclosure.

The positive active material for a rechargeable lithium battery according to one or more embodiments of the present disclosure may be doped with heterogeneous elements, so the positive active material may have a stabilized structure. Accordingly, the voltage (e.g., operating voltage) may become higher, and when the positive active material according to one or more embodiments of the present disclosure is employed in a rechargeable lithium battery, the rechargeable lithium battery may have a high power and a high energy density.

In addition, when the positive active material for a rechargeable lithium battery according to one or more embodiments of the present disclosure is applied for a rechargeable lithium battery, it may further improve stability, storage characteristics, and cycle-life characteristics even under high temperature conditions.

### BRIEF DESCRIPTION OF THE DRAWINGS

FIG. 1 is a schematic view showing a structure of a rechargeable lithium battery according to one or more embodiments of the present disclosure.

FIG. 2 is a plot of dQ/dV vs. voltage (potential) for the rechargeable lithium battery cell according to Example 9.

FIG. 3 is a plot of dQ/dV vs. voltage (potential) for the rechargeable lithium battery cell according to Comparative Example 2-1.

FIG. 4 is a plot of dQ/dV vs. voltage (potential) for the rechargeable lithium battery cell according to Comparative Example 2-10.

### DETAILED DESCRIPTION

The present disclosure will be described more fully hereinafter with reference to the accompanying drawings, in which example embodiments of the present disclosure are shown. The present disclosure may be modified in different ways without departing from the spirit and/or scope of the present disclosure.

In the drawings, parts having no relationship with the description may be omitted for clarity. The same or similar constituent elements are indicated by the same reference numerals throughout the specification, and duplicative descriptions thereof may not be provided.

The size and thickness of each constituent element as shown in the drawings may be modified or arbitrarily chosen for better understanding and ease of description, and it will be understood that embodiments of the present disclosure are not necessarily limited to those shown. It will be understood that when an element such as a layer, film, region, or substrate is referred to as being “on” another element, it can be directly on the other element or intervening element(s) may also be present. In contrast, when an element is referred to as being “directly on” another element, no intervening elements are present.

In addition, unless explicitly stated, the word “comprise” and variations such as “comprises” or “comprising”, will be understood to imply the inclusion of stated elements but not the exclusion of any other elements. Expressions such as “at least one of”, “one of”, “selected from”, “at least one selected from”, and “one selected from”, when preceding a list of elements, modify the entire list of elements and do not modify the individual elements of the list. Further, the use of “may” when describing embodiments of the present disclosure refers to “one or more embodiments of the present disclosure.”

A positive active material for a rechargeable lithium battery according to one or more embodiments of the present disclosure may include a compound represented by Chemical Formula 1:

Li₁₊ₓ₁Co₁₋ₓ₂₋ₓ₃₋ₓ₄M1ₓ₂M2ₓ₃M3ₓ₄O₂. Chemical Formula 1

In Chemical Formula 1, 0<x1≤0.03, 0.005≤x2≤0.02, 0.005≤x3≤0.025, 0≤x4≤0.005, and x2+x3>0.01; M1 may be selected from magnesium (Mg), sodium (Na), calcium (Ca), and a combination thereof; M2 may be selected from aluminum (Al), boron (B), iron (Fe) and a combination thereof; and M3 may be selected from titanium (Ti), zirconium (Zr), vanadium (V), chromium (Cr), molybdenum (Mo), tungsten (W), manganese (Mn), nickel (Ni), copper (Cu), silver (Ag), zinc (Zn), silicon (Si), tin (Sn), nitrogen (N), phosphorus (P), sulfur (S), fluorine (F), chlorine (CI), and a combination thereof.

The compound represented by Chemical Formula 1 may be a lithium cobalt-based oxide doped with at least two kinds of metal elements, including M1 and M2. In some embodiments, when M1 and M2 are included together with M3, the rate capability and low temperature charge and discharge characteristics may be further improved.

The lithium cobalt-based oxide (for example, LiCoO₂) may have a R-3m rhombohedral layered structure. For example, LiCoO₂ has a structure in which lithium, cobalt, and oxygen atoms are regularly arranged in the sequence O—Li—O—Co—O—Li—O—Co—O along the [111] crystal plane of a rock salt structure, also known as an O3-type layered structure.

The positive active material including the lithium cobalt-based oxide may be applied to (e.g., included in) a rechargeable lithium battery. When the rechargeable lithium battery is charged, lithium ions may be deintercalated from a crystal lattice of the lithium cobalt-based oxide to the outside of the lattice.

As the charge voltage is increased, the amount of lithium ion deintercalated from the crystal lattice of the lithium cobalt-based oxide is also increased, and at least a part of the O3-type layered structure may be phase-transformed into an O1-type layered structure (e.g., O1 phase) that does not include lithium (Li) in the crystal lattice. When the charge voltage is greater than or equal to about 4.52 V (full cell voltage), the cobalt-based oxide may phase-transform into a H1-3 type layered structure (e.g., H1-3 phase), in which both the O3 type layered structure and the O1 type layered structure are present in the crystal lattice of the lithium cobalt-based oxide.

The phase transition from the O3 type layered structure to the H1-3 type layered structure and the O1 type layered structure is at least partially irreversible, such that the capacity of lithium ions that may be intercalated/deintercalated from the cathode is decreased in the H1-3 type layered structure and the O1 type layered structure. For example, the phase transitions may rapidly deteriorate the storage and cycle-life characteristics of the rechargeable lithium battery.

According to one or more embodiments of the present disclosure, the dopant (e.g., structurally stabilizing dopant atom) may be very important for obtaining stability and cycle-life characteristics of the rechargeable lithium battery under high voltage conditions, for example, voltages of greater than or equal to about 4.4 V (full cell voltage).

As shown in Chemical Formula 1, when at least two kinds of elements M1 and M2 are doped in amounts of x2 and x3, respectively, the crystal structure of the lithium cobalt-based oxide particle may have improved structural stability even under high temperature and high voltage conditions, and the rechargeable lithium battery including the same may have improved storage characteristics and cycle-life characteristics at high temperature.

For example, when a coin type half-cell is manufactured using the positive active material including the compound represented by Chemical Formula 1 according to one or more embodiments of the present disclosure, and evaluated under high temperature and high voltage conditions of 4.55 V, the rechargeable lithium battery may have a capacity of greater than or equal to about 204 mAh/g, exhibit excellent efficiency, cycle-life retention, and thermal stability, and may also generate a significantly decreased amount of gas.

In some embodiments, in Chemical Formula 1, x2 and x3 may satisfy Equation 1:

0.01≤x2≤0.02 Equation 1

0.01≤x3≤0.02.

In some embodiments, in Chemical Formula 1, x2 and x3 may satisfy x2+x3>0.01, and may further satisfy Equation 2:

0.015≤x2+x3≤0.04. Equation 2

In Chemical Formula 1, when x2 and x3 satisfy the ranges of Equations 1 and 2, the high-temperature stability, cycle-life, and storage characteristics may be improved.

In some embodiments, in the compounds represented by Chemical Formula 1 that are included in the positive active material according to embodiments of the present disclosure, M1 may be Mg, and M2 may be Al. For example, when Mg and Al are included as a dopant, Mg may be present at a Co site to suppress cobalt (Co) elution, and Al may be substituted for trivalent Co to maintain the crystal structure at a state that lithium is escaped (e.g., at a low [Li⁺] state or deintercalated state), thereby improving the structural stability of the positive active material and enabling a rechargeable lithium battery having excellent cycle-life and high temperature storage characteristics.

In some embodiments, the compound represented by Chemical Formula 1 may be, for example, at least one of Li_{1.01}Co_{0.98}Mg_{0.01}Al_{0.01}O₂, Li_{1.01}Co_{0.97}Mg_{0.015}Al_{0.015}O₂, Li_{1.01}Co_{0.97}Mg_{0.02}Al_{0.01}O₂, Li_{1.01}Co_{0.97}Mg_{0.01}Al_{0.02}O₂, Li_{1.03}Co_{0.984}Mg_{0.005}Al_{0.01}Ti_{0.001}O₂, Li_{1.03}Co_{0.98}Mg_{0.005}Al_{0.015}O₂, Li_{1.03}Co_{0.974}Mg_{0.005}Al_{0.02}Ti_{0.001}O₂, Li_{1.03}Co_{0.969}Mg_{0.005}Al_{0.025}Ti_{0.001}O₂, Li_{1.03}Co_{0.979}Mg_{0.01}Al_{0.01}Ti_{0.001}O₂, Li_{1.03}Co_{0.975}Mg_{0.01}Al_{0.015}O₂, Li_{1.03}Co_{0.969}Mg_{0.01}Al_{0.02}Ti_{0.001}O₂, Li_{1.03}O_{0.979}Mg_{0.015}Al_{0.005}Ti_{0.001}O₂, Li_{1.03}Co_{0.974}Mg_{0.015}Al_{0.01}Ti_{0.001}O₂, Li_{1.03}Co_{0.97}Mg_{0.015}Al_{0.015}O₂, Li_{1.03}Co_{0.964}Mg_{0.015}Al_{0.02}Ti_{0.001}O₂, Li_{1.03}Co_{0.974}Mg_{0.02}Al_{0.005}Ti_{0.001}O₂, Li_{1.03}Co_{0.969}Mg_{0.02}Al_{0.0i}Ti_{0.001}O₂, and/or Li_{1.03}Co_{0.964}Mg_{0.02}Al_{0.015}Ti_{0.001}O₂.

A rechargeable lithium battery according to one or more embodiments of the present disclosure includes a positive electrode, a negative electrode and an electrolyte solution.

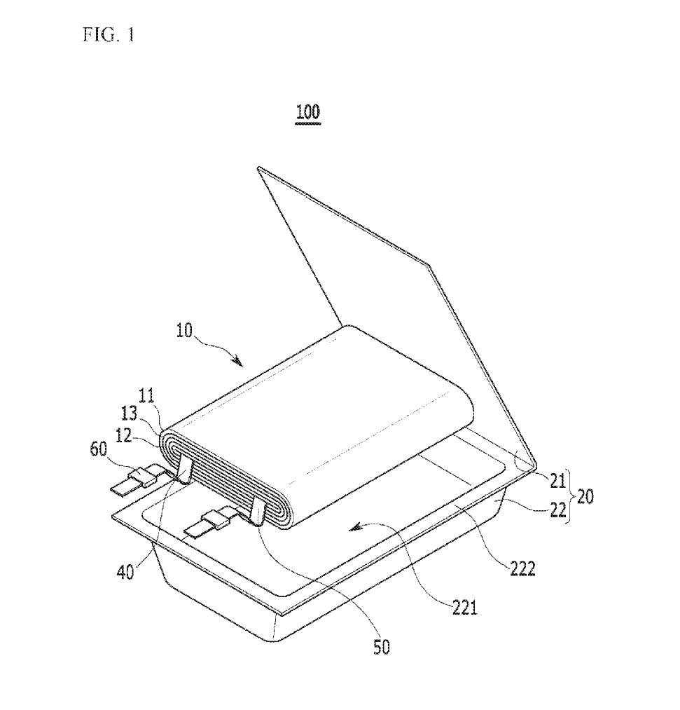

Hereinafter, a rechargeable lithium battery according to one or more embodiments is described with reference to FIG. 1.

FIG. 1 is a schematic view showing a structure of a rechargeable lithium battery according to one or more embodiments of the present disclosure.

Referring to FIG. 1, a rechargeable lithium battery 100 includes an electrode assembly 10, an exterior material 20 housing the electrode assembly 10, and a positive terminal 40 and a negative electrode terminal 50 electrically connected to the electrode assembly 10.

The electrode assembly 10 may include a positive electrode 11, a negative electrode 12, a separator 13 between the positive electrode 11 and the negative electrode 12, and an electrolyte solution impregnating the positive electrode 11, the negative electrode 12, and the separator 13.

The positive electrode 11 may be a positive electrode including the positive active material for a rechargeable lithium battery as described above.

The positive electrode 11 may include a positive active material layer on a positive electrode current collector. The positive active material layer includes a positive active material, and the positive active material may include the positive active material for a rechargeable lithium battery according to one or more embodiments of the present disclosure.

In the positive active material layer, an amount of the positive active material may be about 90 wt % to about 98 wt % based on the total weight of the positive active material layer.

The positive active material layer may further include a binder and a conductive material. Herein, the content of the binder and the conductive material may each independently be about 1 wt % to about 5 wt % based on the total weight of the positive active material layer.

The binder may improve the binding properties of positive active material particles with each another and with a current collector. Non-limiting examples of the binder may include polyvinyl alcohol, carboxymethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like.

The conductive material may provide or increase the conductivity of the electrode. Any electrically conductive material may be used as a conductive material as long as it does not cause an adverse chemical change (e.g., reaction). Non-limiting examples of the conductive material may include a carbon-based material (such as natural graphite, artificial graphite, carbon black, acetylene black, Ketjenblack®, a carbon fiber, and/or the like); a metal-based material in the form of, e.g., a metal powder or a metal fiber and including copper, nickel, aluminum, silver, and/or the like; a conductive polymer (such as a polyphenylene derivative and/or the like); or a mixture thereof.

The positive current collector may include an aluminum foil, a nickel foil, or a combination thereof, but embodiments of the present disclosure are not limited thereto.

The negative electrode 12 includes a negative electrode current collector and a negative active material layer on the current collector. The negative active material layer includes a negative active material.

The negative active material may include a material that reversibly intercalates/deintercalates lithium ions, a lithium metal, a lithium metal alloy, a material capable of doping/dedoping lithium, and/or a transition metal oxide.

The material that reversibly intercalates/deintercalates lithium ions may include a carbon material. The carbon material may be any suitable carbon-based negative active material available for a rechargeable lithium battery. Non-limiting examples of the carbon-based negative active material may include crystalline carbon, amorphous carbon, or mixtures thereof. The crystalline carbon may be a non-shaped carbon (e.g., carbon having an unspecified shape), or sheet, flake, spherical, or fiber shaped natural graphite or artificial graphite. The amorphous carbon may be a soft carbon, a hard carbon, a mesophase pitch carbonization product, fired coke, and/or the like.

The lithium metal alloy may include an alloy including lithium and a metal selected from Na, potassium (K), rubidium (Rb), cesium (Cs), francium (Fr), beryllium (Be), magnesium (Mg), Ca, strontium (Sr), Si, antimony (Sb), Pb, indium (In), Zn, barium (Ba), radium (Ra), germanium (Ge), Al, Sn, and mixtures thereof.

The material capable of doping/dedoping lithium may be a silicon-based material, for example, Si, SiOₓ (0<x<2), a Si-Q alloy (wherein Q is an element selected from an alkali metal, an alkaline-earth metal, a Group 13 element, a Group 14 element excluding Si, a Group 15 element, a Group 16 element, a transition metal, a rare earth element, and combinations thereof), a Si-carbon composite, Sn, SnO₂, Sn—R alloy (wherein R is an element selected from an alkali metal, an alkaline-earth metal, a Group 13 element, a Group 14 element excluding Sn, a Group 15 element, a Group 16 element, a transition metal, a rare earth element, and combinations thereof), a Sn-carbon composite, and/or the like. At least one of these materials may be mixed with SiO₂. The elements Q and R may be selected from Mg, Ca, Sr, Ba, Ra, scandium (Sc), yttrium (Y), titanium (Ti), Zr, hafnium (Hf), rutherfordium (Rf), vanadium (V), niobium (Nb), tantalum (Ta), dubnium (Db), Cr, molybdenum (Mo), tungsten (W), seaborgium (Sg), technetium (Tc), rhenium (Re), bohrium (Bh), Fe, Pb, ruthenium (Ru), osmium (Os), hassium (Hs), rhodium (Rh), iridium (Ir), palladium (Pd), platinum (Pt), Cu, Ag, gold (Au), Zn, cadmium (Cd), B, Al, gallium (Ga), Sn, In, Ge, P, arsenic (As), antimony (Sb), bismuth (Bi), sulfur (S), selenium (Se), tellurium (Te), polonium (Po), and combinations thereof.

The transition metal oxide may include lithium titanium oxide.

In the negative active material layer, the negative active material may be included in an amount of about 95 wt % to about 99 wt % based on the total weight of the negative active material layer.

The negative active material layer may include a negative active material and a binder, and optionally a conductive material.

In the negative active material layer, the negative active material may be included in an amount of about 95 wt % to about 99 wt % based on the total weight of the negative active material layer. In the negative active material layer, a content of the binder may be about 1 wt % to about 5 wt % based on the total weight of the negative active material layer. When the negative active material layer includes a conductive material, the negative active material layer may include about 90 wt % to about 98 wt % of the negative active material, about 1 wt % to about 5 wt % of the binder, and about 1 wt % to about 5 wt % of the conductive material.

The binder may improve the binding properties of the negative active material with itself and with a current collector. The binder may be a non-water-soluble binder, a water-soluble binder, or a combination thereof.

The non-water-soluble binder may be or include polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, or a combination thereof.

The water-soluble binder may be or include a styrene-butadiene rubber, an acrylated styrene-butadiene rubber, a polyvinyl alcohol, sodium polyacrylate, a copolymer of propylene and a C2 to C8 olefin, a copolymer of (meth)acrylic acid and (meth)acrylic acid alkyl ester, or a combination thereof.

When the water-soluble binder is used as a negative electrode binder, a cellulose-based compound may be further used to provide viscosity as a thickener. The cellulose-based compound may include one or more of carboxymethyl cellulose, hydroxypropylmethyl cellulose, methyl cellulose, or an alkali metal salt thereof. The alkali metal may be Na, K, and/or Li. The thickener may be included in an amount of about 0.1 parts to about 3 parts by weight based on 100 parts by weight of the negative active material.

The conductive material may provide or increase electrode conductivity. Any electrically conductive material may be used as a conductive material as long as it does not cause an adverse chemical change (e.g., reaction). Non-limiting examples of the conductive material may include a carbon-based material (such as natural graphite, artificial graphite, carbon black, acetylene black, Ketjenblack®, Denka black, carbon fiber, and/or the like); a metal-based material in the form of, e.g., a metal powder or a metal fiber including copper, nickel, aluminum, silver, and/or the like; a conductive polymer (such as a polyphenylene derivative); and/or a mixture thereof.

The negative current collector may include one selected from a copper foil, a nickel foil, a stainless steel foil, a titanium foil, a nickel foam, a copper foam, a polymer substrate coated with a conductive metal, and a combination thereof.

In some embodiments, the electrode assembly 10, as shown in FIG. 1, may have a structure obtained by interposing a separator 13 between the band-shaped positive electrode 11 and negative electrode 12, spirally winding them, and compressing the wound assembly into flat or flattened shape. In some embodiments, a plurality of quadrangular sheet-shaped positive and negative electrodes may be alternately stacked with a plurality of separators therebetween.

An electrolyte solution may be impregnated in the positive electrode 11, the negative electrode 12, and the separator 13.

The separator 13 may be any suitable separator for a lithium battery that can separate the positive electrode 11 and the negative electrode 12 while providing a transporting passage for lithium ions. The separator may have low resistance to ion transport and be easily impregnated with an electrolyte solution. The separator 13 may be, for example, a glass fiber, polyester, polyethylene, polypropylene, polytetrafluoroethylene, or a combination thereof. The separator may have a form of a non-woven fabric or a woven fabric. In some embodiments, the separator may be polyolefin-based polymer separator (such as polyethylene and/or polypropylene). In order to improve the heat resistance or mechanical strength, a coated separator including a ceramic component or a polymer material may be used. Optionally, it may have a mono-layered or multi-layered structure.

The electrolyte solution may include a non-aqueous organic solvent and a lithium salt.

The non-aqueous organic solvent may serve as a medium for transmitting ions taking part in the electrochemical reaction of a battery.

The non-aqueous organic solvent may include a carbonate-based, ester-based, ether-based, ketone-based, alcohol-based, or aprotic solvent. The carbonate-based solvent may include dimethyl carbonate (DMC), diethyl carbonate (DEC), dipropyl carbonate(DPC), methylpropyl carbonate (MPC), ethylpropyl carbonate (EPC), methylethyl carbonate (MEC), ethylene carbonate (EC), propylene carbonate

(PC), butylene carbonate (BC), and/or the like. The ester-based solvent may include methyl acetate, ethyl acetate, n-propyl acetate, dimethylacetate, methylpropionate, ethylpropionate, γ-butyrolactone, decanolide, valerolactone, mevalonolactone, caprolactone, and/or the like. The ether-based solvent may include dibutyl ether, tetraglyme, diglyme, dimethoxyethane, 2-methyltetrahydrofuran, tetrahydrofuran, and/or the like. The ketone-based solvent may include cyclohexanone and/or the like. The alcohol based solvent may include ethanol, isopropyl alcohol, and/or the like, and the aprotic solvent may include nitriles (such as R—CN (where R is a C2 to C20 linear, branched, or cyclic hydrocarbon group, a double bond, and may include an aromatic ring, or an ether bond), and/or the like), amides (such as dimethyl formamide and/or the like), dioxolanes (such as 1,3-dioxolane and/or the like), sulfolanes, and/or the like.

The non-aqueous organic solvent may be used alone or in a mixture. When the organic solvent is used in a mixture, the mixture ratio may be selected to enable desirable or suitable battery performance.

The carbonate-based solvent may include a mixture of a cyclic carbonate and a linear (chain) carbonate. When the cyclic carbonate and linear carbonate are mixed together in a volume ratio of about 1:1 to about 1:9, electrolyte performance may be improved.

In some embodiments, the non-aqueous organic solvent may further include an aromatic hydrocarbon-based organic solvent in addition to the carbonate-based solvent. Herein, the carbonate-based solvent and the aromatic hydrocarbon-based organic solvent may be mixed in a volume ratio of about 1:1 to about 30:1.

The aromatic hydrocarbon-based organic solvent may be an aromatic hydrocarbon-based compound of Chemical Formula 3:

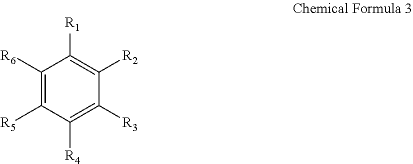

In Chemical Formula 3, R₁ to R₆ may each independently be the same or different, and may be selected from hydrogen, a halogen, a C1 to C10 alkyl group, a haloalkyl group, and a combination thereof.

Non-limiting examples of the aromatic hydrocarbon-based organic solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

In some embodiments, the non-aqueous electrolyte may further include vinylene carbonate or an ethylene carbonate-based compound of Chemical Formula 4 in order to improve battery cycle life:

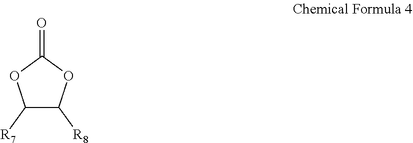

In Chemical Formula 4, R₇ and R₈ may each independently be the same or different, and may be selected from hydrogen, a halogen, a cyano group (CN), a nitro group (NO₂), and a fluorinated C1 to C5 alkyl group, provided that at least one of R₇ and R₈ is selected from a halogen, a cyano group (CN), a nitro group (NO₂), and fluorinated C1 to C5 alkyl group, and R₇ and R₈ are not simultaneously (e.g., both) hydrogen.

Non-limiting examples of the ethylene carbonate-based compound may be difluoro ethylenecarbonate, chloroethylene carbonate, dichloroethylene carbonate, bromoethylene carbonate, dibromoethylene carbonate, nitroethylene carbonate, cyanoethylene carbonate, or fluoroethylene carbonate, and/or the like. The amount of the additive for improving cycle life may be used within an appropriate or suitable range.

The lithium salt may be dissolved in the organic solvent to supply the battery with lithium ions, operate the rechargeable lithium battery, and improve lithium ion transport between the positive and negative electrodes. Non-limiting examples of the lithium salt may include LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) (wherein x and y are natural numbers, for example an integer ranging from 1 to 20), LiCl, LiI, and/or LiB(C₂O₄)₂ (lithium bis(oxalato) borate; LiBOB). The lithium salt may be used in a concentration ranging from about 0.1 M to about 2.0 M. When the lithium salt is included at the above concentration range, the electrolyte may have excellent performance and lithium ion mobility due to optimal or suitable electrolyte conductivity and viscosity.

The separator 13 between the positive electrode 11 and the negative electrode 12 may be a polymer film. The separator may include for example, polyethylene, polypropylene, and/or polyvinylidene fluoride, and multi-layer structures thereof (such as a polyethylene/polypropylene double-layered separator, a polyethylene/polypropylene/polyethylene triple-layered separator, and/or a polypropylene/polyethylene/polypropylene triple-layered separator).

The exterior material 20 may consist of a lower exterior material 22 and an upper exterior material 21, and the electrode assembly 10 is housed in an internal space 221 of the lower exterior material 22.

The electrode assembly 10 may be housed (e.g., placed) in the exterior material 20, and a sealant may be applied on a sealing region 222 along the edge of the lower exterior material 22 to seal the upper exterior material 21 and the lower exterior material 22. The parts or regions where the positive terminal 40 and the negative electrode terminal 50 are in contact with the exterior material 20 may be wrapped with an insulation member 60 to improve the durability of the rechargeable lithium battery 100.

The rechargeable lithium battery according to one or more embodiments of the present disclosure may have a working voltage upper limit of, for example, about 4.3 V to about 4.8 V, about 4.4 V to about 5.7 V, about 4.50 V to about 4.65 V, or about 4.55 V to about 4.60 V. Here, the working voltage of the rechargeable lithium battery is based on the half-type coin cell (e.g., vs. Li/Li⁺).

The rechargeable lithium battery including the positive active material as described above according to one or more embodiments of the present disclosure may realize excellent storage and cycle-life characteristics while simultaneously (e.g., at the same time) having high output and energy density even when driven under high-voltage conditions.

The rechargeable lithium battery according to one or more embodiments of the present disclosure may be included in a device. Non-limiting examples of the device may include, for example, a mobile phone, a tablet computer, a laptop computer, a power tool, a wearable electronic device, an electric vehicle, a hybrid electric vehicle, a plug-in hybrid electric vehicle, and a power storage device. Devices including a rechargeable lithium battery are well known in the related art, and will not be further illustrated.

Hereinafter, additional aspects of embodiments of the present disclosure will be illustrated through Examples.

### EXAMPLE 1

### (1) Manufacture of Positive Electrode

Lithium carbonate, cobalt oxide, magnesium carbonate, aluminum oxide, and titanium oxide were mixed to provide a Li:Co:Mg:Al:Ti mole ratio of 1.03:0.984:0.005:0.01:0.001.

The mixture was heat treated at 1050° C. for 20 hours under an oxygen (O₂)-containing atmosphere to provide a positive active material of Li_{1.03}O_{0.984}Mg_{0.005}Al_{0.01}Ti_{0.001}O₂.

94 wt % of the positive active material, 3 wt % of a polyvinylidene fluoride binder, and 3 wt % of a Ketjenblack® conductive material were mixed in a N-methylpyrrolidone solvent to provide a positive active material composition. The positive active material composition was coated on an aluminum current collector to provide a positive electrode.

### (2) Manufacture of Rechargeable Lithium Battery Cell

Using the positive electrode obtained from (1), a lithium metal counter electrode, and an electrolyte solution, a coin-shaped half-cell having a capacity (nominal capacity) of 190 mAh was manufactured according to a generally-used method. The electrolyte solution was obtained by dissolving 1.0 M of LiPF₆ in a mixed solvent of ethylene carbonate (EC) and diethyl carbonate (DEC) (50:50 volume ratio).

### EXAMPLES 2 TO 17 AND COMPARATIVE EXAMPLES 1-1 TO 1-2, 2-1 TO 2-18

Each positive electrode and each half-cell according to Examples 2 to 17 and Comparative Examples 1-1 to 1-2 and 2-1 to 2-18 were manufactured using substantially the same procedure as in Example 1, except that they were mixed to provide a mole ratio of Co:Mg:Al:Ti as shown in Table 1 together with the fixed mole ratio of Li to provide a positive active material and to provide a positive electrode.

TABLE 1

| | | | | | Mg + Al |
|---|---|---|---|---|---|
| | Co | Mg = x2 | Al = x3 | Ti = x4 | (=x2 + x3) |
| Example 1 | 0.984 | 0.005 | 0.010 | 0.001 | 0.015 |
| Example 2 | 0.98 | 0.005 | 0.015 | 0 | 0.02 |
| Example 3 | 0.974 | 0.005 | 0.02 | 0.001 | 0.025 |
| Example 4 | 0.969 | 0.005 | 0.025 | 0.001 | 0.03 |
| Example 5 | 0.979 | 0.01 | 0.01 | 0.001 | 0.02 |
| Example 6 | 0.975 | 0.01 | 0.015 | 0 | 0.025 |
| Example 7 | 0.969 | 0.01 | 0.02 | 0.001 | 0.03 |
| Example 8 | 0.979 | 0.015 | 0.005 | 0.001 | 0.02 |
| Example 9 | 0.974 | 0.015 | 0.01 | 0.001 | 0.025 |
| Example 10 | 0.97 | 0.015 | 0.015 | 0 | 0.03 |
| Example 11 | 0.964 | 0.015 | 0.02 | 0.001 | 0.035 |
| Example 12 | 0.974 | 0.02 | 0.005 | 0.001 | 0.025 |
| Example 13 | 0.969 | 0.02 | 0.01 | 0.001 | 0.03 |
| Example 14 | 0.964 | 0.02 | 0.015 | 0.001 | 0.035 |
| Example 15 | 0.959 | 0.015 | 0.025 | 0.001 | 0.04 |
| Example 16 | 0.984 | 0.01 | 0.005 | 0.001 | 0.015 |
| Example 17 | 0.964 | 0.01 | 0.025 | 0.001 | 0.035 |
| Comparative | 0.969 | 0.025 | 0.005 | 0.001 | 0.03 |
| Example 1-1 | | | | | |
| Comparative | 0.964 | 0.025 | 0.01 | 0.001 | 0.035 |
| Example 1-2 | | | | | |
| Comparative | 0.999 | 0 | 0 | 0.001 | 0 |
| Example 2-1 | | | | | |
| Comparative | 0.994 | 0.005 | 0 | 0.001 | 0.005 |
| Example 2-2 | | | | | |
| Comparative | 0.989 | 0.01 | 0 | 0.001 | 0.01 |
| Example 2-3 | | | | | |
| Comparative | 0.984 | 0.015 | 0 | 0.001 | 0.015 |
| Example 2-4 | | | | | |
| Comparative | 0.993 | 0.005 | 0.001 | 0.001 | 0.006 |
| Example 2-5 | | | | | |
| Comparative | 0.988 | 0.01 | 0.001 | 0.001 | 0.011 |
| Example 2-6 | | | | | |
| Comparative | 0.983 | 0.015 | 0.001 | 0.001 | 0.016 |
| Example 2-7 | | | | | |
| Comparative | 0.998 | 0 | 0.001 | 0.001 | 0.001 |
| Example 2-8 | | | | | |
| Comparative | 0.994 | 0 | 0.005 | 0.001 | 0.005 |
| Example 2-9 | | | | | |
| Comparative | 0.989 | 0 | 0.01 | 0.001 | 0.01 |
| Example 2-10 | | | | | |
| Comparative | 0.984 | 0 | 0.015 | 0.001 | 0.015 |
| Example 2-11 | | | | | |
| Comparative | 0.979 | 0 | 0.02 | 0.001 | 0.02 |
| Example 2-12 | | | | | |
| Comparative | 0.974 | 0 | 0.025 | 0.001 | 0.025 |
| Example 2-13 | | | | | |
| Comparative | 0.993 | 0.001 | 0.005 | 0.001 | 0.006 |
| Example 2-14 | | | | | |
| Comparative | 0.988 | 0.001 | 0.01 | 0.001 | 0.011 |
| Example 2-15 | | | | | |
| Comparative | 0.978 | 0.001 | 0.02 | 0.001 | 0.021 |
| Example 2-16 | | | | | |
| Comparative | 0.973 | 0.001 | 0.025 | 0.001 | 0.026 |
| Example 2-17 | | | | | |
| Comparative | 0.989 | 0.005 | 0.005 | 0.001 | 0.01 |
| Example 2-18 | | | | | |

### EXPERIMENTAL EXAMPLE 1

### Measurement of Charge and Discharge Characteristics

Each half-cell manufactured according to Examples 1 to 17 and Comparative Examples 1-1 to 1-2 and 2-1 to 2-18 was charged and discharged at 25° C. within a range from 4.55 V to 3.0 V at a charge rate of 0.2 C to evaluate its initial charge and discharge characteristics. Table 2 shows the initial charge and discharge capacity efficiency for each cell at 0.2 C.

### EXPERIMENTAL EXAMPLE 2

### High Temperature Cycle-life Characteristics

Each half-cell manufactured according to Examples 1 to 17 and Comparative Examples 1-1 to 1-2 and 2-1 to 2-18 was charged and discharged according to a constant current-constant voltage (CC-CV) profile at 45° C., in particular, using a CC charge rate of 1.0 C and a trickle current of 0.05 C up to a cut-off voltage of 4.55 V, and a CC discharge rate of 1.0 C to a cut-off voltage of 3.0 V. A capacity ratio calculated from the ratio of the 100th discharge capacity with respect to the first discharge capacity was obtained to illustrate the high temperature (45° C.) cycle-life characteristics. The results are shown in Table 2.

TABLE 2

| | | Initial | |
|---|---|---|---|
| | | charge and | |
| | | discharge | |
| | 0.2 C | capacity | |
| | charge | efficiency | 45° C. |
| | capacity | at 0.2 C | cycle-life |
| | (mAh/g) | (%) | (%) |
| Example 1 | 214 | 96.5 | 60.1 |
| Example 2 | 213 | 96.3 | 63.8 |
| Example 3 | 209 | 95.8 | 65.1 |
| Example 4 | 207 | 95.1 | 65.4 |
| Example 5 | 211 | 95.6 | 79.4 |
| Example 6 | 210 | 95.2 | 83.0 |
| Example 7 | 208 | 94.1 | 75.1 |
| Example 8 | 212 | 96.0 | 70.5 |
| Example 9 | 209 | 95.2 | 85.1 |
| Example 10 | 207 | 94.8 | 90.60 |
| Example 11 | 206 | 94.0 | 77.5 |
| Example 12 | 200 | 94.5 | 72.4 |
| Example 13 | 202 | 94.2 | 78.4 |
| Example 14 | 200 | 93.4 | 77.5 |
| Example 15 | 204 | 92.5 | 77.0 |
| Example 16 | 213 | 96.1 | 60.0 |
| Example 17 | 206 | 94.0 | 76.4 |
| Comparative | 192 | 92.0 | 65.4 |
| Example 1-1 | | | |
| Comparative | 190 | 91.5 | 71.1 |
| Example 1-2 | | | |
| Comparative | 219 | 98.1 | 0.2 |
| Example 2-1 | | | |
| Comparative | 217 | 97.8 | 14.6 |
| Example 2-2 | | | |
| Comparative | 216 | 97.6 | 38.5 |
| Example 2-3 | | | |
| Comparative | 214 | 97.2 | 48.0 |
| Example 2-4 | | | |
| Comparative | 215 | 97.5 | 26.0 |
| Example 2-5 | | | |
| Comparative | 214 | 97.1 | 46.1 |
| Example 2-6 | | | |
| Comparative | 212 | 96.8 | 58.2 |
| Example 2-7 | | | |
| Comparative | 217 | 97.8 | 8.8 |
| Example 2-8 | | | |
| Comparative | 216 | 97.4 | 14.6 |
| Example 2-9 | | | |
| Comparative | 215 | 97.0 | 30.2 |
| Example 2-10 | | | |
| Comparative | 214 | 96.8 | 48.0 |
| Example 2-11 | | | |
| Comparative | 211 | 96.1 | 45.2 |
| Example 2-12 | | | |
| Comparative | 210 | 96.0 | 33.0 |
| Example 2-13 | | | |
| Comparative | 215 | 97.1 | 46.3 |
| Example 2-14 | | | |
| Comparative | 214 | 96.7 | 52.6 |
| Example 2-15 | | | |
| Comparative | 210 | 95.8 | 54.2 |
| Example 2-16 | | | |
| Comparative | 208 | 95.4 | 43.8 |
| Example 2-17 | | | |
| Comparative | 215 | 97.1 | 50.4 |
| Example 2-18 | | | |

Referring to Table 2, it is confirmed that the half-cells according to Examples 1 to 17 exhibited improved and/or satisfactory capacity at 0.2 C, improved and/or satisfactory initial charge and discharge efficiency, and improved and/or satisfactory high temperature cycle-life characteristics.

On the other hand, the half-cells according to Comparative Examples 1-1 to 1-2 had excellent high temperature cycle-life characteristics but had remarkably deteriorated initial charge and discharge efficiency, while the half-cells according to Comparative Examples 2-1 to 2-18 had very deteriorated high temperature cycle-life characteristics.

### EXPERIMENTAL EXAMPLE 3

### Measurement of dQ/dV Change

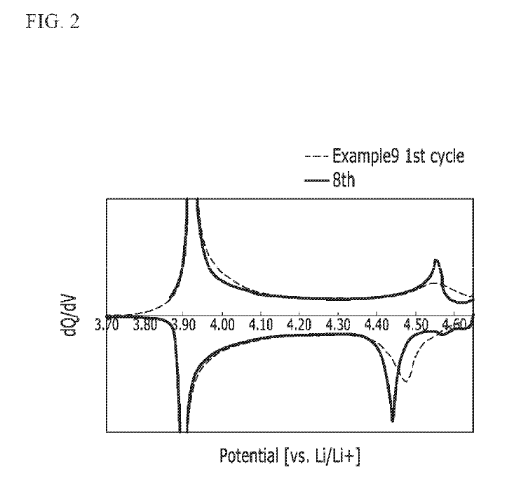

The half-cells according to Example 9, Comparative Examples 2-1 and 2-10 were subjected to charge and discharge at 25° C. within a voltage range of 4.7 V to 3.0 V at a charge and discharge current rate of 0.1 C, and a plot of dQ/dV vs. voltage (potential) was obtained. Next, the charge and discharge was repeated for 8 times under the same conditions, and another plot of dQ/dV vs. voltage (potential) was obtained and compared to the first cycle plot, as shown in FIGS. 2-4.

Referring to FIG. 2, the half-cell according to Example 9 showed a dQ/dV plot that was little changed between the first (1st) cycle and the eighth (8th) cycle, confirming that the structure of the positive active material was stably maintained even at a high voltage.

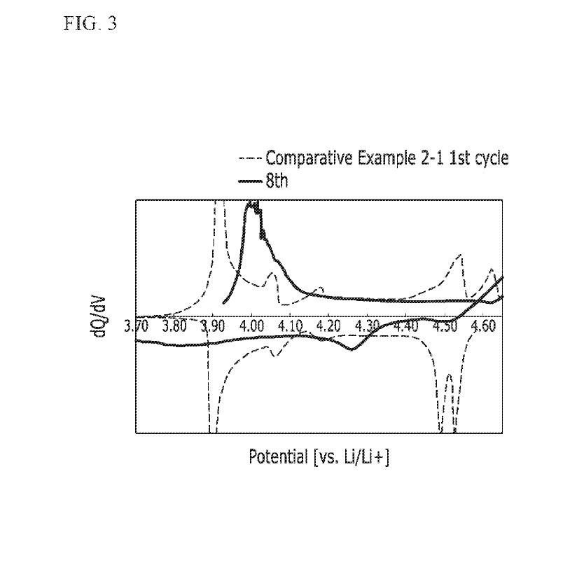

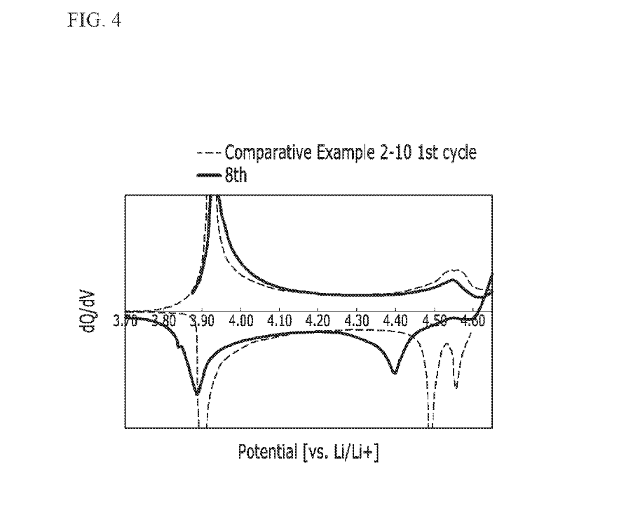

On the other hand, referring to FIGS. 3 and 4, the half-cells according to Comparative Examples 2-1 and 2-10 showed dQ/dV plots that were significantly changed between the first (1st) cycle and the eighth (8th) cycle, confirming that the structure of the positive active material was not stably maintained.

### Experimental Example 4

### Evaluation of Gas Generation

The amount of gas generated by the half-cells according to Examples 5, 6, 9, and 10 and Comparative Examples 2-1, 2-3, 2-4, 2-13, and 2-15 at high voltage was measured according to the following method.

Each half-cell was charged at 0.2 C until 4.55 V to a state of charge (SOC) of 100%, and then the half-cell was dissembled to isolate the positive electrode. The separated positive electrode was inserted into an aluminum (Al) pouch having a size of 10 cm×4 cm together with the electrolyte solution and sealed and stored at 80° C. for 14 days, after which the amount of gas generated within the pouch was evaluated, and the results are shown in Table 3.

Referring to Table 3, it can be seen that the half-cells according to Examples 5, 6, 9, and 10 generated comparatively less gas even after being stored at high temperature. On the other hand, it can be seen that the half-cells according to Comparative Examples 2-1, 2-3, 2-4, 2-13, and 2-15 generated remarkably higher amounts of gas after being stored at high temperature, compared to the half-cells according to the Examples.

### EXPERIMENTAL EXAMPLE 5

### Evaluation of Co Elution

The half-cells according to Examples 5, 6, 9, and 10 and Comparative Examples 2-1, 2-3, 2-4, 2-13, and 2-15 were analyzed for Co elution (e.g., amounts of eluted Co) according to the following method.

The half-cell was charged at 0.2 C until 4.55 V to a SOC of 100%, and then the half-cell was dissembled to isolate the positive electrode. The separated positive electrode was added into a 10 mL volume Teflon container together with the electrolyte solution and sealed and then stored at 85° C. for 7 days, and then the Co content was measured by ICP-MS analysis, and the results are shown in Table 3.

Referring to Table 3, it can be seen that the half-cells according to Examples 5, 6, 9, and 10 had relatively low amounts of eluted Co. However, the half-cells according to Comparative Examples 2-1, 2-3, 2-4, 2-13, and 2-15 had remarkably higher amounts of eluted cobalt (Co) was compared to the Examples. Thus, in the half-cells according to the Examples, the amount of gas generated during high temperature storage may be significantly decreased, and the amount of eluted Co ions caused by reaction with the electrolyte solution may also be decreased.

TABLE 3

| | Gas | Co |
|---|---|---|
| | generation | elution |
| | amount | amount |
| | (cc/g) | (ppm) |
| Example 5 | 8 | 100 |
| Example 6 | 6 | 38 |
| Example 9 | 6 | 25 |
| Example 10 | 5 | 22 |
| Comparative | 15 | 450 |
| Example 2-1 | | |
| Comparative | 13 | 350 |
| Example 2-3 | | |
| Comparative | 12 | 355 |
| Example 2-4 | | |
| Comparative | 10 | 270 |
| Example 2-13 | | |
| Comparative | 9 | 210 |
| Example 2-15 | | |

### EXPERIMENTAL EXAMPLE 6

### Differential Scanning Calorimetry (DSC) Evaluation

A DSC evaluation was carried out to evaluate the thermal stability of the cells. The DSC evaluation was performed using a Q2000 DSC (TA Instruments) in calorie change mode.

The half-cells according to Examples 5, 6, 9, and 10 and Comparative

Examples 2-1, 2-3, and 2-10 were charged at 0.2 C until 4.55 V to a SoCC (State of Charge) of 100%, and the half-cell was dissembled to isolate the positive electrode. The separated electrode was washed with DMC (dimethyl carbonate) and dried for at least 10 hours, after which the positive active material was peeled off from the current collector, added to the electrolyte solution (weight ratio of positive active material and electrolyte solution=1: 2), and subjected to DSC evaluation.

The measurement scan rate was 5° C./minute. The results are shown in Table 4.

TABLE 4

| | 1st peak |
|---|---|
| | (° C.) |
| Example 5 | 240 |
| Example 6 | 245 |
| Example 9 | 242 |
| Example 10 | 252 |
| Comparative | 221 |
| Example 2-1 | |
| Comparative | 224 |
| Example 2-3 | |
| Comparative | 231 |
| Example 2-11 | |

### EXPERIMENTAL EXAMPLE 7

### Evaluation for Storing High Temperature

The half-cells according to Example 9 and Comparative Examples 2-4 and 2-11 were measured for a capacity change before and after being stored at a high temperature of 60° C. according to the following method.

First, each half-cell was charged and discharged at 0.2 C within a voltage range of 4.55 V to 3.0 V, and charged until 4.55 V to a SOC of 100% to measure a capacity before being stored at high temperature. The half-cells were stored in an oven at 60° C. for 7 days, discharged once at 0.2 C until 3.0 V to obtain a capacity retention (Rt), and then continuously (substantially continuously) charged and discharged three times at 0.2 C to give the maximum value from the obtained values, which is a capacity recovery (Rc) value . The results are shown in Table 5.

TABLE 5

| | Rt (%) | Rc (%) |
|---|---|---|
| | 7 days @ 60° C._4.55 V | 7 days @ 60° C._4.55 V |
| Example 9 | 73.8 | 85.5 |
| Comparative | 55.6 | 74.2 |
| Example 2-4 | | |
| Comparative | 30.7 | 33.9 |
| Example 2-11 | | |

Referring to Table 5, it is confirmed that the half-cell according to Example 9 had significantly higher capacity retention (Rt) and capacity recovery (Rc) even after being stored at high temperature, compared to the half-cells according to Comparative Examples 2-4 and 2-11. Accordingly, it is understood that the rechargeable lithium battery cell according to an embodiment of the present disclosure may maintain excellent characteristics even after being stored at high temperature.

As used herein, the terms “use”, “using”, and “used” may be considered synonymous with the terms “utilize”, “utilizing”, and “utilized”, respectively. Further, the use of “may” when describing embodiments of the present disclosure refers to “one or more embodiments of the present disclosure”.

As used herein, the terms “substantially”, “about”, and similar terms are used as terms of approximation and not as terms of degree, and are intended to account for the inherent deviations in measured or calculated values that would be recognized by those of ordinary skill in the art.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

It should be understood that example embodiments described herein should be considered in a descriptive sense only and not for purposes of limitation. Descriptions of features or aspects within each example embodiment should typically be considered as available for other similar features or aspects in other example embodiments.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims and equivalents thereof.

### DESCRIPTION OF SOME OF THE SYMBOLS

100: rechargeable lithium battery
11: positive electrode
12: negative electrode
13: separator
20: exterior material

What is claimed is:

1. A positive active material for a rechargeable lithium battery, comprising a compound represented by Chemical Formula 1:
Li₁₊ₓ₁Co₁₋ₓ₂₋ₓ₃₋ₓ₄M1ₓ₂M2ₓ₃M3ₓ₄O₂. Chemical Formula 1
wherein, in Chemical Formula 1,
0<x1≤0.03, 0.005≤x2≤0.02, 0.005≤x3≤0.025, 0≤x4≤0.005, and x2+x3>0.01,
M1 is selected from Mg, Na, Ca, and a combination thereof,
M2 is selected from Al, B, Fe, and a combination thereof, and
M3 is selected from Ti, Zr, V, Cr, Mo, W, Mn, Ni, Cu, Ag, Zn, Si, Sn, N, P, S, F, Cl, and a combination thereof.

2. The positive active material of claim 1, wherein in Chemical Formula 1, x2 and x3 satisfy Equation 1:
0.01≤x2≤0.02
0.01≤x3≤0.02. Equation 1

3. The positive active material of claim 1, wherein in Chemical Formula 1, x2 and x3 satisfy Equation 2:
0.015≤x2+x3≤0.04. Equation 2

4. The positive active material of claim 1, wherein in Chemical Formula 1, M1 is Mg and M2 is Al.

5. The positive active material of claim 1, wherein the compound represented by Chemical Formula 1 is at least one of Li₁.ₒ₁Co_{0.98}Mg_{0.01}Al_{0.01}O₂, Li_{1.01}Co_{0.97}Mg_{0.015}Al_{0.015}O₂, Li_{1.01}Co_{0.97}Mg_{0.02}Al_{0.01}O₂, Li_{1.01}Co_{0.97}Mg_{0.01}Al_{0.02}O₂, Li_{1.03}Co_{0.984}Mg_{0.005}Al_{0.01}Ti_{0.001}O₂, Li_{1.03}Co_{0.98}Mg_{0.005}Al_{0.015}O₂, Li_{1.03}Co_{0.974}Mg_{0.005}Al_{0.02}Ti_{0.001}O₂, Li_{1.03}Co_{0.969}Mg_{0.005}Al_{0.025}Ti_{0.001}O₂, Li_{1.03}Co_{0.979}Mg_{0.01}Al_{0.01}Ti_{0.001}O₂, Li_{1.03}Co_{0.975}Mg_{0.01}Al_{0.015}O₂, Li_{1.03}Co_{0.969}Mg_{0.01}Al_{0.02}Ti_{0.001}O₂, Li_{1.03}Co_{0.979}Mg_{0.015}Al_{0.005}Ti_{0.001}O₂, Li_{1.03}Co_{0.974}Mg_{0.015}Al_{0.01}Ti_{0.001}O₂, Li_{1.03}Co_{0.97}Mg_{0.015}Al_{0.015}O₂, Li_{1.03}Co_{0.964}Mg_{0.015}Al_{0.02}Ti_{0.001}O₂, Li_{1.03}Co_{0.974}Mg_{0.02}Al_{0.005}Ti_{0.001}O₂, Li_{1.03}Co_{0.969}Mg_{0.02}Al_{0.01}Ti_{0.001}O₂, Li_{1.03}Co_{0.964}Mg_{0.02}Al_{0.015}Ti_{0.001}O₂, Li_{1.03}Co_{0.959}Mg_{0.015}Al_{0.025}Ti_{0.001}O₂, Li_{1.03}Co_{0.984}Mg_{0.01}Al_{0.005}Ti_{0.001}O₂, and Li_{1.03}Co_{0.964}Mg_{0.01}Al_{0.025}Ti_{0.001}O₂.

6. A rechargeable lithium battery, comprising:
a positive electrode;
a negative electrode; and
an electrolyte solution,
wherein the positive electrode comprises the positive active material of claim 1.

7. The rechargeable lithium battery of claim 6, wherein the rechargeable lithium battery has a working voltage of about 4.3 V to about 4.8 V.

8. The rechargeable lithium battery of claim 6, wherein the rechargeable lithium battery has a working voltage of about 4.4 V to about 4.7 V.

9. The rechargeable lithium battery of claim 6, wherein in Chemical Formula 1, x2 and x3 satisfy Equation 1:
0.01≤x2≤0.02
0.01≤x3≤0.02. Equation 1

10. The rechargeable lithium battery of claim 6, wherein in Chemical Formula 1, x2 and x3 satisfy Equation 2:
0.015≤x2+x3≤0.04. Equation 2

11. The rechargeable lithium battery of claim 6, wherein in Chemical Formula 1, M1 is Mg and M2 is Al.

12. The rechargeable lithium battery of claim 6, wherein the compound represented by Chemical Formula 1 is at least one of Li_{1.01}Co_{0.98}Mg_{0.01}Al_{0.01}O₂, Li_{1.01}Co_{0.97}Mg_{0.015}Al_{0.015}O₂, Li_{1.01}Co_{0.97}Mg_{0.02}Al_{0.01}O₂, Li_{1.01}Co_{0.97}Mg_{0.01}Al_{0.02}O₂, Li_{1.03}Co_{0.984}Mg_{0.005}Al_{0.01}Ti_{0.001}O₂, Li_{1.03}Co_{0.98}Mg_{0.005}Al_{0.015}O₂, Li_{1.03}Co_{0.974}Mg_{0.005}Al_{0.02}Ti_{0.001}O₂, Li_{1.03}C_{0.969}Mg_{0.005}Al_{0.025}Ti_{0.001}O₂, Li_{1.03}Co_{0.979}Mg_{0.01}Al_{0.01}Ti_{0.001}O₂, Li_{1.03}Co_{0.975}Mg_{0.01}Al_{0.015}O₂, Li_{1.03}Co_{0.969}Mg_{0.01}Al_{0.02}Ti_{0.001}O₂, Li_{1.03}Co_{0.979}Mg_{0.015}Al_{0.005}Ti_{0.001}O₂, Li_{1.03}Co_{0.974}Mg_{0.015}Al_{0.01}Ti_{0.001}O₂, Li_{1.03}Co_{0.97}Mg_{0.015}Al_{0.015}O₂, Li_{1.03}Co_{0.964}Mg_{0.015}Al_{0.02}Ti_{0.001}O₂, Li_{1.03}Co_{0.974}Mg_{0.02}Al_{0.005}Ti_{0.001}O₂, Li_{1.03}Co_{0.969}Mg_{0.02}Al_{0.01}Ti_{0.001}O₂, and Li_{1.03}Co_{0.964}Mg_{0.02}Al_{0.015}Ti_{0.001}O₂.
